(19) United States
(12) Patent Application Publication
(10) Pub. No.: US 2007/0162226 A1
(43) Pub. Date: Jul. 12, 2007

(54) Addressable GPS device

(76) Inventor: Tsai-Yun Chen, Hsin Chu (TW)

Correspondence Address: SCHMEISER, OLSEN & WATTS, 22 CENTURY HILL DRIVE, SUITE 302, LATHAM, NY, 12110, US

(21) Appl. No.: 11/331,378

(22) Filed: Jan. 12, 2006

(51) Int. Cl. G01C 21/00

(52) U.S. Cl. 701/213; 701/200

(57) ABSTRACT

The present invention provides an addressable GPS device, comprising a cover body, an electrical circuit, a GPS module and a Wi-Fi module. The electrical circuit is located inside the cover body, wherein an antenna is located on the electrical circuit to receive and transmit signals. A satellite antenna is formed on the GPS module to receive satellite signals so that GPS module can transform those satellite signals into data of a holder geographic position of the addressable GPS device with respect to the position's longitude, latitude, height, and his traveling speed and traveling distance. The Wi-Fi module has a fixed internet address programmed thereon. A Wi-Fi station is utilized to receive and transmit the fixed internet address and an internet access device is used to access the fixed internet address so that the GPS holder's geographic location can be obtained accurately.

### BACKGROUND OF THE INVENTION

The present invention relates generally to a combination of a satellite navigation system, such as a Global Positioning Systems (GPS), with network of Wireless Fidelity (Wi-Fi). More particularly, the present invention relates to a device comprising a GPS with Wi-Fi network to trace and locate the geographic position of the GPS holder irrespective of the surveillance distance.

### DESCRIPTION OF THE RELATED ART

The technology of GPS is popular and is commonly utilized in the navigation field, more particularly, the utilization of GPS on the transportation means. The conventional method is to install an antenna on the transportation means to receive the positioning satellite signals, and those positioning satellite signals would be transmitted to a main device. The main device would transform those signals into data of a GPS holder's geographic position in terms of the location's longitude, latitude, height, and his traveling speed and traveling distance. The main device comprises a cellular telephone, wherein the cellular telephone would be utilized to transmit those data of the position of the GPS holder with respect to his geographic location's longitude, latitude, height, and his traveling speed and traveling distance as text messages to a control center. The workers in the control center would then transfer those data onto a map in order to obtain the exact location of the GPS holder so that the information regarding the location of the GPS holder can be passed on to the GPS holder through the cellular telephone. In other words, the control center was essential for the conventional GPS holder to allocate his or her position. For the GPS holder, he or she cannot obtain information related to his or her location directly without passing through the control center.

The GPS device can be used to help locating lost children, disabled elders, or pets. However, the current GPS device's design cannot be used in those cases because we cannot access to the direct information without passing through the control center. Most common methods used to look for lost ones such as the children, the elders, the disabled people or the pets are either through the newspapers, the internet, the advertisements or the police. But the searching process is normally slow and time consuming, and in some urgent cases, timing is crucial for finding those lost people. It is, therefore, an object of the present invention to provide a GPS device that can be utilized in those cases by combining its technology with the Wi-Fi and the internet. Thus, the GPS can be utilized in finding lost persons, the lost pets or the stolen cars.

### SUMMARY OF THE INVENTION

It is an object of the present invention to provide a device by combining the technologies of GPS with Wi-Fi network to trace and locate the position of the GPS holder's position. The present invention provides an addressable GPS device that can directly provide a location of the GPS holder.

It is another object of the present invention to provide a design of an addressable GPS device that is convenient to use, portable easily and can be connected quickly to the internet so that the holder of GPS device with the fixed internet address can be located in respect of his/her geographic position quickly.

The present invention provides an addressable GPS device, comprising a cover body, an electrical circuit, a GPS module and a Wi-Fi module. The electrical circuit is located inside the cover body, wherein an antenna is located on the electrical circuit to receive and transmit signals. A satellite antenna is formed on the GPS module of the electrical circuit. The GPS module receives satellite signals, and transforms those satellite signals into data of a location of a holder of the GPS with the fixed internet address with respect to his geographic location's longitude, latitude, height, his traveling speed and traveling distance. The Wi-Fi module is located on the electrical circuit and has a fixed internet address programmed thereon. The Wi-Fi module is utilized to receive and transmit the fixed internet address through a Wi-Fi station, wherein an internet access device is used to access the fixed internet address. Thus, the GPS holder's location with respect to the geographic location's longitude, latitude, height, and his traveling speed and traveling distance can be obtained accurately and quickly. The addressable GPS device of the present invention can trace and locate the position of the GPS holder without the limitation of the monitoring distance.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1 is a 3-D diagram of an assembly of an addressable GPS device in accordance with a preferred example of the present invention;

FIG. 2 is a 3-D diagram of a completely assembled addressable GPS device of the present invention;

FIG. 3 is a schematic diagram showing a utilization of addressable GPS device in according to a preferred embodiment of the present invention.

### DESCRIPTION OF THE PREFERRED EMBODIMENTS

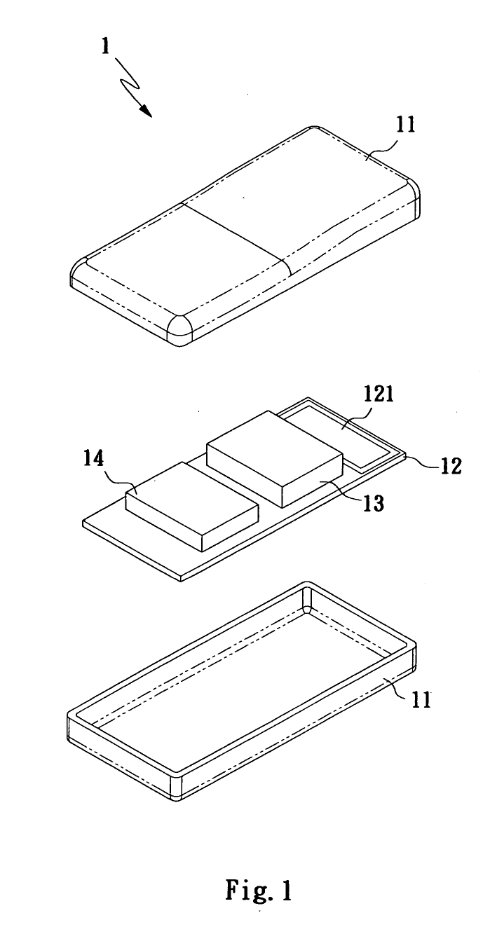

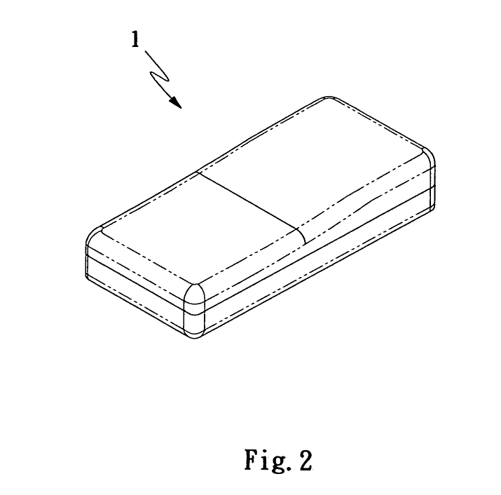

FIGS. 1, 2 and 3 illustrate an assembled structure of an addressable GPS device according to a preferred example of the present invention. The present invention provides an improved design of an addressable Global Positioning Systems (GPS) device 1, wherein the addressable GPS device comprises a fixed internet address programmed thereon. The fixed internet address can be an Internet Protocol (IP) address. The addressable GPS device 1 further comprises a cover body 11, an electrical circuit 12, a GPS module 13 and a wireless fidelity (Wi-Fi) module 14. The cover body 11 comprises an upper cover and a bottom cover as shown in FIG. 1. The electrical circuit 12 is located within the cover body 11, wherein an antenna 121 for receiving signals is positioned on the electrical circuit 12.

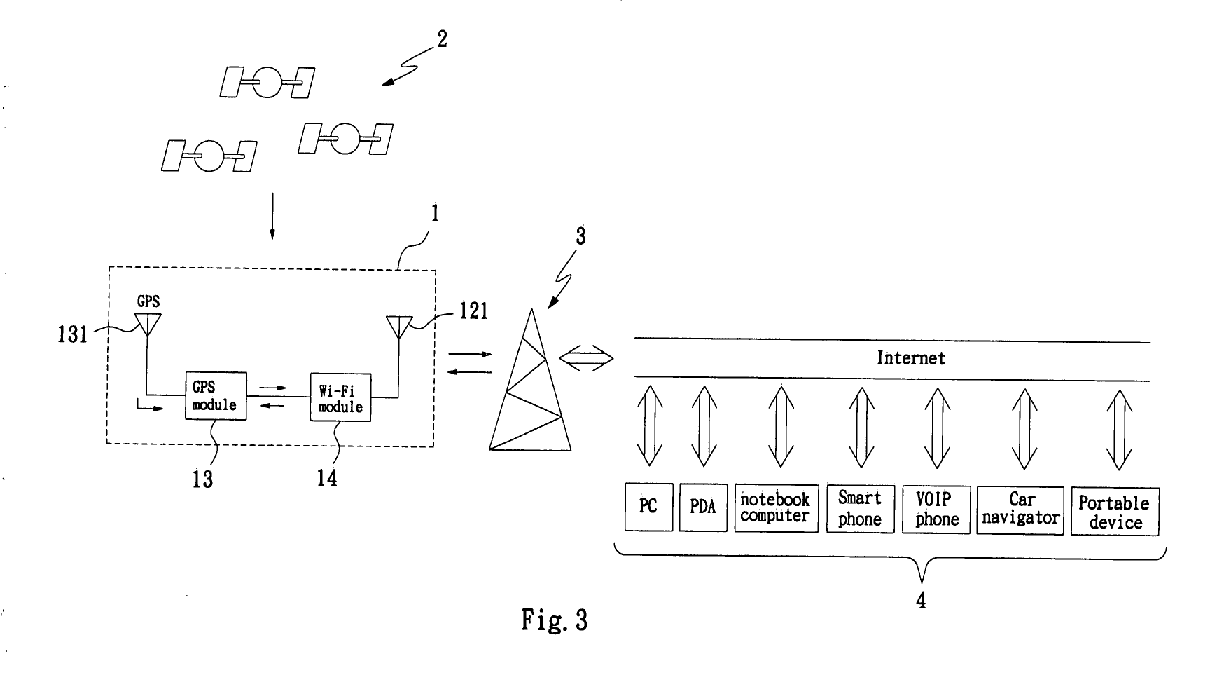

The GPS module 13 is also located on the electrical circuit 12, wherein a satellite antenna 131 , for receiving signals from positioning satellites 2 as shown in FIG. 3, is positioned on the GPS module 13. The satellite antenna 131 can receive the signals from the positioning satellites 2, and the GPS module 13 transforms those signals into data of a GPS holder's geographic position with respect to the position's longitude, latitude, height, his traveling speed and traveling distance.

The Wi-Fi module 14 is located on the electrical circuit 12, wherein a fixed internet address is programmed on the Wi-Fi module 14 (the fixed network communication address can be one of the fixed addresses of an IP address or a Media Access Control (MAC) address ). An internet access device 4 is utilized to access to the fixed internet address through the Wi-Fi station 3 so that the Wi-Fi module 14 can receive or transmit the fixed internet address such as the IP or the MAC address in order to obtain the data relating to the geographic location of the holder of the addressable GPS device in terms of its longitude, latitude, height, his traveling speed and traveling distance.

FIG. 3 shows a schematic diagram showing a utilization of the addressable GPS device according to a preferred embodiment of the present invention. Once the satellite antenna 13 located inside the addressable GPS device 1 receives the satellite signals from the positioning satellites 2, the satellite signals will then be transferred and transmitted by the GPS module 13 into data indicating the addressable GPS holder's geographic location with respect to his position's longitude, latitude, height, and his traveling speed and traveling distance. Those data will then be transmitted through the GPS module 13 to the Wi-Fi module 14. The Wi-Fi module 14 will utilize the antenna 121 to communicate with the Wi-Fi station 3 so that the data of the addressable GPS holder's geographic location with respect to its location's longitude, latitude, height, and his traveling speed and traveling distance can be updated continuously. Therefore, the latest data of the holder's position of the addressable GPS device with respect to the geographic location's longitude, latitude, height, his traveling speed and traveling distance can be updated continuously and accurately.

When the user obtains the fixed IP or the MAC address of the Wi-Fi module 14, the user can utilize the Personal Computer (PC), or a notebook computer, or a handheld device, such as a Personal Digital Assistant (PDA), or the smart phone, or the Voice Over Internet Protocol (VOIP) phone, or the car navigator or the portable device to connect/access to the internet. Once the user is connected to the internet, the Wi-Fi station 3 will then communicate with the addressable GPS device 1 so that the user can access and receive the data of the addressable GPS device holder's geographic position with respect to the location's longitude, latitude, height, his traveling speed and traveling distance. Those data are then utilized and transferred onto an internet map so that the geographic location of the person being pursued or tracked can be located on the map.

The present invention provides an addressable GPS device 1 utilizing and combining the technologies of GPS and Wi-Fi to create a device that can accurately trace the latest geographic position of a holder of the addressable GPS device. Furthermore, the present invention provides a design of the addressable GPS device that is convenient to use, portable, and can be connected quickly to the internet so that the holder of the addressable GPS device with the fixed internet address can be located with respect to his/her geographic position quickly through the satellite. The utilization of the fixed internet address, such as the IP or the MAC address, on the addressable GPS device can also cut down the service cost of the control center because the addressable GPS device of the present invention can directly obtain the latest information regarding the geographic position of the addressable GPS holder. Therefore, no matter whether the user or the holder of the addressable GPS device of the fixed internet address is a disabled elder or a young child or a pet, the geographic position of the addressable GPS holder can be traced and located easily through the communication between the addressable GPS device with the internet and the satellite.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. An addressable Global Positioning Systems (GPS) device, comprising:
a cover body;
an electrical circuit, locating inside the cover body, wherein an antenna is located on the electrical circuit to receive and transmit signals;
a GPS module, locating on the electrical circuit, wherein a satellite antenna is formed on the GPS module to receive satellite signals, the GPS module transforms those satellite signals into data of a geographic position of a holder of the GPS device with the fixed internet address with respect to the geographic position's longitude, latitude, height, and his traveling speed and traveling distance; and
a Wi-Fi module, positioning on the electrical circuit, wherein a fixed internet address is programmed on the Wi-Fi module, a Wi-Fi station is utilized to receive and transmit the fixed internet address and an internet access device is used to access the fixed internet address so that the data of the GPS holder's geographic location with respect to the location's longitude, latitude, height, and his traveling speed and traveling distance can be obtained.

2. The device of claim 1, wherein the fixed internet address can be either an Internet Protocol (IP) address or a Media Access Control (MAC) address.

3. The device of claim 1, wherein the internet access device can be either a Personal Computer (PC), a notebook computer, a Personal Digital Assistant (PDA), a smart phone, a Voice Over Internet Protocol (VOIP) phone, a car navigator or a portable device.
